(19) United States
(12) Patent Application Publication
(10) Pub. No.: US 2025/0017304 A1
(43) Pub. Date: Jan. 16, 2025

(54) Head Restraint System and Method

(71) Applicant: Phoenix Calandrella, Atlanta, GA (US)

(72) Inventor: Phoenix Calandrella, Atlanta, GA (US)

(21) Appl. No.: 18/635,473

(22) Filed: Apr. 15, 2024

Related U.S. Application Data
(60) Provisional application No. 63/525,741, filed on Jul. 10, 2023.

(51) Int. Cl. A42B 1/0195; B60N 2/80

(52) U.S. Cl. CPC A42B 1/0195; B60N 2/80; B60N 2002/899

(57) ABSTRACT

A head restraint system includes: a mounting component, wherein the mounting component includes a first fastener component; and a headgear component adapted to secure a user's forehead, wherein the headgear component includes a second fastener component. The first fastener component removably attaches to the second fastener component to secure the mounting component to the headgear component. Methods for restraining a head of a user are also described.

### FIELD OF THE DISCLOSURE

This application claims the benefit of U.S. Provisional Application No. 63/525,741, filed Jul. 10, 2023, the disclosure of which is incorporated herein by this reference in its entirety.

### FIELD OF THE DISCLOSURE

The present disclosure relates to a head restraint system that stabilizes a user's head above their neck.

### BACKGROUND OF THE DISCLOSURE

When seated upright, an individual's spine supports the head, but the neck muscles must engage to keep the head stabilized. If the neck muscles relax—such as when the individual falls asleep—the head will fall forward or to the side, leaving the individual uncomfortable and restricting airflow. Currently, it is difficult to sleep (comfortably or otherwise) in an upright seated position. Conventional solutions such as neck pillows and wadded up blankets inserted between the head and shoulder help prevent the head from falling forward or to the side, but do not sufficiently stabilize the head on top of the spine to allow the individual to rest or sleep while in an upright seated position.

U.S. Pat. No. 7,004,545 describes a head support device including a support member adapted to be disposed between a user and a seat surface, a securing member capable of restraining the user's head, and an attachment apparatus capable of attaching the support member and the securing member. The support apparatus provides a resilient support when disposed between the user and the seat surface, and the securing means is capable of securing the user's head to the support apparatus, wherein the securing means secures the user's head to the support apparatus at a position behind the user's head. The attachment apparatus enables reversible attachment and wherein the device is not secured to the user at any point lower than the user's chin. This solution describes a stand-alone support device, but the support member is rigid or semi-rigid and the apparatus does not provide for a portable, removable, or even permanent mounting device to a vertical surface.

U.S. Pat. No. 9,795,219 describes a head restraint travel accessory including a harness, wings, a head restraint band, and an inflatable contoured pillow configured to be positioned between the harness and said head restraint band. This approach includes a pillow and requires the user to be strapped against the seat of a vehicle.

These and other shortcomings are addressed by aspects of the present disclosure.

### SUMMARY

Aspects of the disclosure relate to a head restraint system including: a mounting component, wherein the mounting component includes a first fastener component; and a headgear component adapted to secure a user's forehead, wherein the headgear component includes a second fastener component. The first fastener component removably attaches to the second fastener component to secure the mounting component to the headgear component.

Aspects of the disclosure further relate to a method for restraining a head of a user, the method including: attaching a mounting component to a vertical surface, wherein the mounting component includes a first fastener component; attaching a headgear component to a user's forehead, wherein the headgear component includes a second fastener component; and attaching the first fastener component to the second fastener component to restrain the user's forehead in place against the vertical surface, wherein the first fastener component is removably attached to the second fastener component.

### BRIEF DESCRIPTION OF THE FIGURES

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document.

FIG. 1 is a side perspective view of a head restraint system according to aspects of the disclosure.

FIG. 2 is a front view of a mounting component according to aspects of the disclosure.

FIG. 3 is a front view of another mounting component according to aspects of the disclosure.

FIG. 4 is a rear perspective view of a headgear component according to aspects of the disclosure.

FIG. 5 is a front perspective view of a aircraft seat according to aspects of the disclosure.

FIG. 6 is front perspective view of another aircraft seat according to aspects of the disclosure.

FIG. 7 is a front perspective view of a portable infant seat according to aspects of the disclosure.

FIG. 8 is a front view of a vertical surface (wall) with a plurality of mounting components attached to the wall according to aspects of the disclosure.

FIG. 9 is a front perspective view of a headband according to aspects of the disclosure.

FIG. 10 is a front perspective view of another headband according to aspects of the disclosure.

### DETAILED DESCRIPTION

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting.

Various combinations of elements of this disclosure are encompassed by this disclosure, e.g., combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

### DEFINITIONS

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used in the specification and the appended claims, the singular forms “a,” “an” and “the” include plural referents unless the context clearly dictates otherwise.

Ranges can be expressed herein as from one value (first value) to another value (second value). When such a range is expressed, the range includes in some aspects one or both of the first value and the second value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the designated value, approximately the designated value, or about the same as the designated value. It is generally understood, as used herein, that it is the nominal value indicated +10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

### Head Restraint System

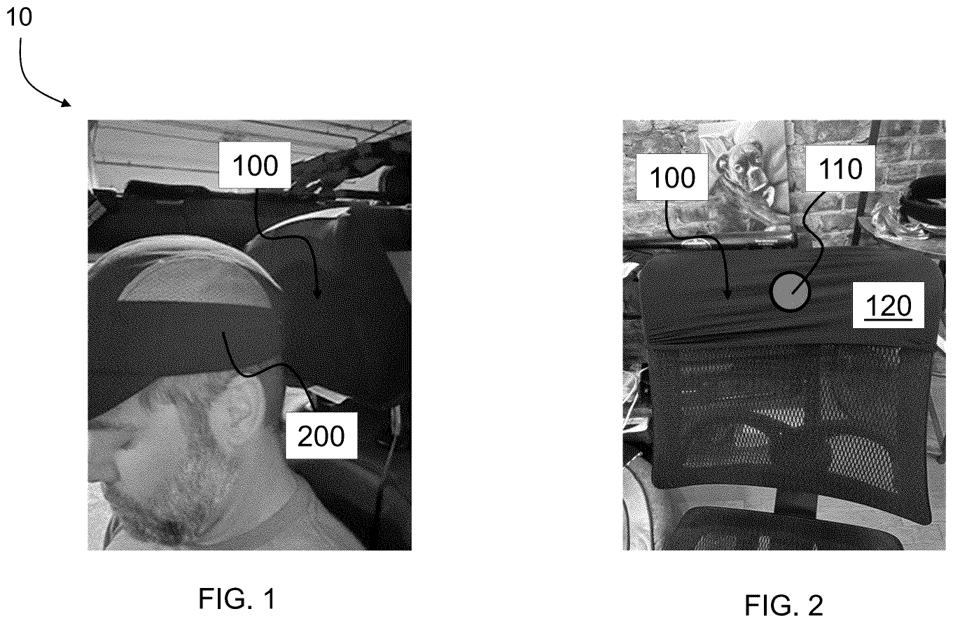

With reference to FIGS. 1-10, aspects of the disclosure relate to a head restraint system 10 including: a mounting component 100, wherein the mounting component 100 includes a first fastener component 110; and a headgear component 200 adapted to secure a user's forehead, wherein the headgear component 200 includes a second fastener component 210. The first fastener component 110 removably attaches to the second fastener component 210 to secure the mounting component 100 to the headgear component 200.

The head restraint system 10 allows an individual who is seated upright—or who is laying/sitting at an angle above horizonal—to have their head supported by the spine and stabilized by the system, thereby allowing their neck muscles to relax and enabling them to sleep, rest or relax comfortably in an upright position. There are no current solutions which allow an individual to turn a headrest/chair/etc. or any other vertical surface into a method which allows for the head to be stabilized on the spine without requiring the head to be strapped to the surface. The system may also be useful for individuals with neck issues, as it could help alleviate neck pain by supporting the user's head over their spine.

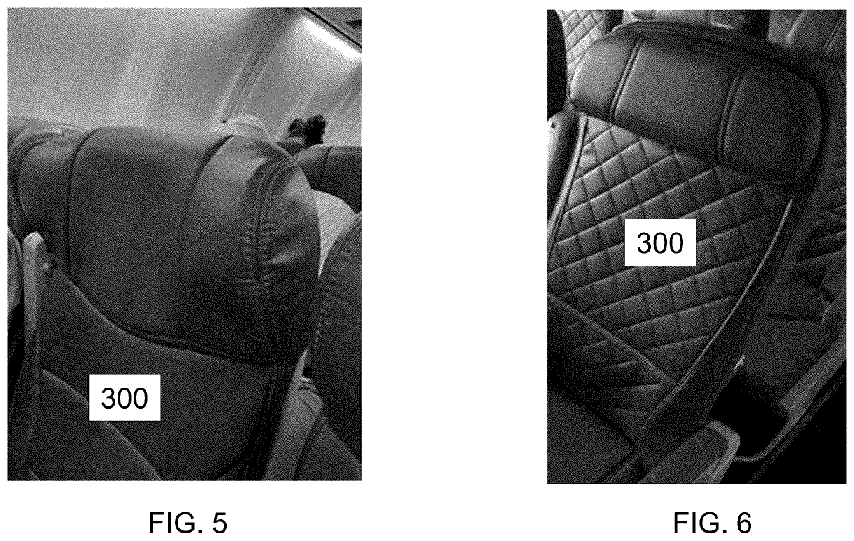

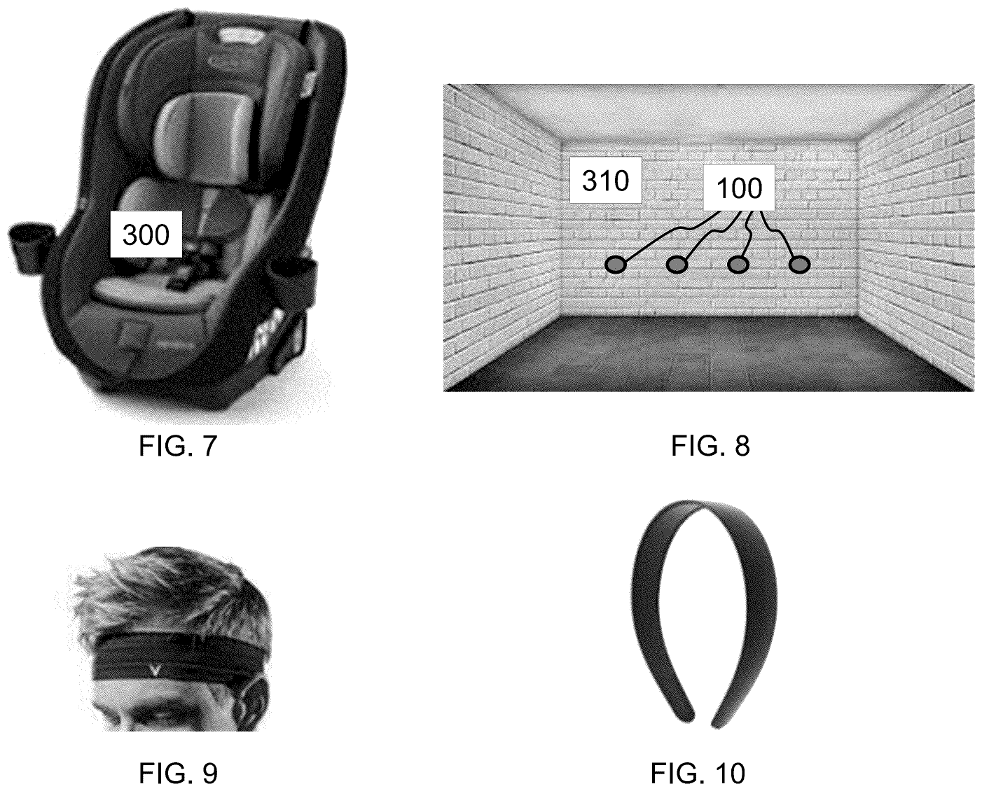

In some aspects the mounting component 100 is adapted to attach to a seat 300 or be incorporated within the seat 300, or be incorporated within a vertical surface 310 (e.g., a wall). In certain aspects the seat 300 is a component of a transportation vehicle (e.g., an automobile (FIG. 1), aircraft (FIGS. 5 and 6), train, or boat), a chair (e.g., a desk or office chair) (FIG. 2), a couch, or a portable infant seat (FIG. 7).

In further aspects the mounting component 100 includes a sleeve 120 or a strap 130 adapted to attach to the seat 300 or a portion of the seat 300, and the first fastener component 110 is retained within or on a surface of the sleeve 120 or strap 130. In certain aspects the mounting component 100 prevents the head of the user from direct contact with a seat 300 of a vehicle. The system described herein may thus help to prevent germs/bacteria left on the seat by a previous user from contacting the head of the user.

The sleeve 120 may include a fabric in some aspects. The fabric may be an inelastic or an elastic/stretchable fabric (see FIG. 2). Exemplary inelastic fabrics include, but are not limited to, cordura, cotton (e.g., canvas fabric), dyneema, nylon (e.g., ballistic nylon), and combinations thereof. Exemplary stretchable fabrics include, but are not limited to, spandex/lycra, rubber, and combinations thereof. An inelastic fabric may be particularly desirable in some aspects to prevent the head of the user from pulling away from the seat/vertical surface due to stretching of the fabric.

The fabric may include a third fastener component to secure the first fastener component to the seat. Exemplary third fastener components include, but are not limited to, a drawstring, buckle, or strap.

The mounting component 100 may be adapted to stretch/attach around the entire seat 300 (e.g., around the headrest of the seat) (see, e.g., FIG. 5), or if the seat has adjustable headrest wings (see FIG. 6) the mounting component 100 may be adapted to stretch/attach around the headrest wings.

The sleeve 120 or strap 130 includes an antimicrobial material or antimicrobial surface treatment in some aspects.

In further aspects the first fastener component 110 is removable from the mounting component 100, and/or the second fastener component 210 is removable from the headgear component 200. In this manner, the mounting component 100 and/or the headgear component 200 may be washed (e.g., in a washing machine) without damaging the fastener components.

In some aspects the first fastener component 110 may be quickly removed from the second fastener component 210. As used herein “quickly” has a conventional meaning; i.e., the fasteners may be detached/removed from one another with little or no delay, such as less than 3 seconds, less than 2 seconds, less than 1 second, or even less than 0.5 seconds.

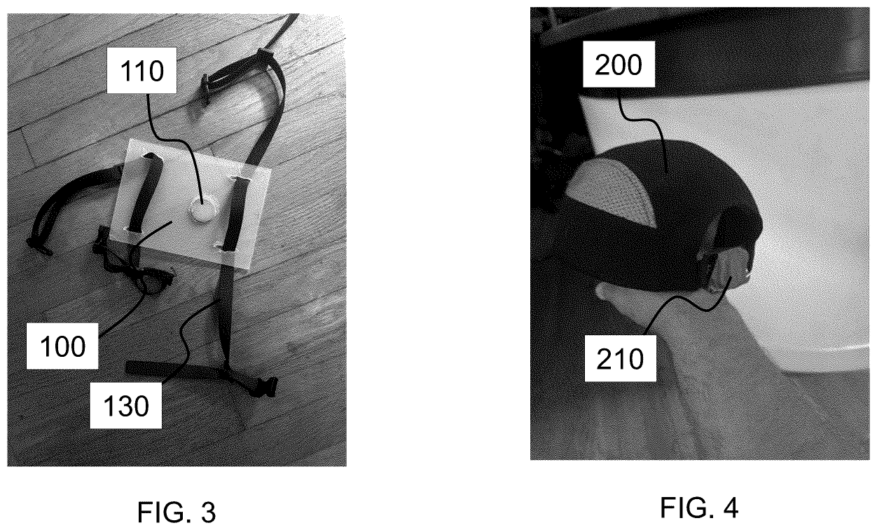

In certain aspects the headgear component 200 includes a hat, a cap (FIGS. 1 and 3), a visor, a headband (FIGS. 9 and 10), a strap, a drawstring, or a combination thereof.

Exemplary fasteners for the first fastening component 110 and the second fastening component 210 include, but are not limited to, a plurality of magnets, a hook and loop fastener, a buckle, a clip, a snap, or a combination thereof. The first fastening component 110 and the second fastening component 210 removably engage with/attaches to one another to secure the mounting component 100 to the headgear component 200. In this manner, the headgear component 200 may be detached from the mounting component 100 without the user having to remove the headgear component 200 from their forehead. For example, if the headgear component 200 is a cap, the user may quickly detach the cap from the mounting component 100 without removing the cap from their head. The user may then move freely from their seat and when they return to their seat quickly re-attach the cap to the mounting component 100.

In some aspects the second fastening component 210 may be adapted to attach to a conventional headgear component that a user already owns or purchases separately. For example, a user may attach the second fastening component 210 (e.g., one of a plurality of magnets) to their personal hat to convert the hat into a headgear component 200 according to aspects of the disclosure.

One or both of the mounting component and the headgear component includes a logo in some aspects.

In some aspects one or more of the mounting component 100 and the headgear component 200 includes a pocket to contain the first fastener component 110 and the second headgear component 210. The pocket may be scalable by conventional means, such as with a zipper, overlapping flaps, or a hook and loop fastener.

In particular aspects the mounting component 100 including the first fastener component 110 is directly attached to a seat 300 of a vehicle or is incorporated within the seat 300 of the vehicle. For example, an airline may choose to install a first fastener component 110 within the headrests/seats of their airplane. Passengers with a headgear component 200 including a second fastener component 210 would be able to just sit down and attach their headgear component to the first fastener component 110 incorporated within the aircraft seat.

### Head Restraint Methods

Aspects of the disclosure further include methods for restraining a user's head with a head restraint system according to aspects described herein.

In particular aspects the method includes: attaching a mounting component to a vertical surface, wherein the mounting component includes a first fastener component; attaching a headgear component to a user's forehead, wherein the headgear component includes a second fastener component; and attaching the first fastener component to the second fastener component to restrain the user's forehead in place against the vertical surface, wherein the first fastener component is removably attached to the second fastener component.

The method may incorporate any of the features of the head restraint system described herein, including but not limited to the features set forth in the Aspects section below.

Various combinations of elements of this disclosure are encompassed by this disclosure, e.g., combinations of elements from dependent claims that depend upon the same independent claim.

### ASPECTS OF THE DISCLOSURE

In various aspects, the present disclosure pertains to and includes at least the following aspects.

Aspect 1. A head restraint system comprising, consisting of, or consisting essentially of:
a mounting component, wherein the mounting component comprises a first fastener component; and
a headgear component adapted to secure a user's forehead, wherein the headgear component comprises a second fastener component,
wherein the first fastener component removably attaches to the second fastener component to secure the mounting component to the headgear component.

Aspect 2. The head restraint system according to Aspect 1, wherein the mounting component is adapted to attach to a seat or be incorporated within the seat, or be incorporated within a vertical surface.

Aspect 3. The head restraint system according to Aspect 2, wherein the seat is a component of a transportation vehicle, a chair, a couch, or a portable infant seat.

Aspect 4. The head restraint system according to Aspect 2 or 3, wherein the mounting component comprises a sleeve or a strap adapted to attach to the seat or a portion of the seat, and the first fastener component is retained within or on a surface of the sleeve or strap.

Aspect 5. The head restraint system according to Aspect 4, wherein the sleeve comprises a fabric.

Aspect 6. The head restraint system according to Aspect 5, wherein the fabric is inelastic or stretchable.

Aspect 7. The head restraint system according to Aspect 5, wherein the fabric comprises a third fastener component to secure the first fastener component to the seat.

Aspect 8. The head restraint system according to any of Aspects 4 to 7, wherein the sleeve or strap comprise an antimicrobial material or antimicrobial surface treatment.

Aspect 9. The head restraint system according to any of Aspects 1 to 8, wherein the first fastener component is removable from the mounting component.

Aspect 10. The head restraint system according to any of Aspects 1 to 9, wherein the second fastener component is removable from the headgear component.

Aspect 11. The head restraint system according to any of Aspects 1 to 10, wherein one or both of the mounting component and the headgear component are machine washable.

Aspect 12. The head restraint system according to any of Aspects 1 to 11, wherein the first fastener component and the second fastener component comprise a plurality of magnets, a hook and loop fastener, a buckle, a snap, or a combination thereof.

Aspect 13. The head restraint system according to any of Aspects 1 to 12, wherein the headgear component comprises a hat, a cap, a visor, a headband, a strap, a drawstring, or a combination thereof.

Aspect 14. The head restraint system according to any of Aspects 1 to 13, wherein one or both of the mounting component and the headgear component comprise a logo.

Aspect 15. The head restraint system according to any of Aspects 1 to 14, wherein one or both of the first fastener component and the second fastening component are removably contained within a pocket in the mounting component or the headgear component.

Aspect 16. The head restraint system according to Aspect 15, wherein the pocket is sealable.

Aspect 17. The head restraint system according to Aspect 16, wherein the pocket comprises a zipper or a hook and loop fastener.

Aspect 18. The head restraint system according to Aspect 1, wherein the mounting component comprising the first fastener component is directly attached to a seat of a vehicle or is incorporated within the seat of the vehicle.

Aspect 19. The head restraint system according to any of Aspects 1 to 18, wherein the mounting component prevents the head of the user from direct contact with a seat of a vehicle.

Aspect 20. The head restraint system according to any of Aspects 1 to 19,

wherein the headgear component may be detached from the mounting component without removing the headgear component from the user's forehead.

Aspect 21. A method for restraining a head of a user, the method comprising, consisting of, or consisting essentially of:
attaching a mounting component to a vertical surface, wherein the mounting component comprises a first fastener component;
attaching a headgear component to a user's forehead, wherein the headgear component comprises a second fastener component; and
attaching the first fastener component to the second fastener component to restrain the user's forehead in place against the vertical surface, wherein the first fastener component is removably attached to the second fastener component.

Aspect 22. The method according to Aspect 21, wherein the mounting component is adapted to attach to a seat or be incorporated within the seat, or be incorporated within the vertical surface.

Aspect 23. The method according to Aspect 22, wherein the seat is a component of a transportation vehicle, a chair, a couch, or a portable infant seat.

Aspect 24. The method according to Aspect 22 or 23, wherein the mounting component comprises a sleeve or a strap adapted to attach to the seat or a portion of the seat, and the first fastener component is retained within or on a surface of the sleeve or strap.

Aspect 25. The method according to Aspect 24, wherein the sleeve comprises a fabric.

Aspect 26. The method according to Aspect 25, wherein the fabric is inelastic or stretchable.

Aspect 27. The method according to Aspect 25, wherein the fabric comprises a third fastener component to secure the first fastener component to the seat.

Aspect 28. The method according to any of Aspects 24 to 27, wherein the sleeve or strap comprise an antimicrobial material or antimicrobial surface treatment.

Aspect 29. The method according to any of Aspects 21 to 28, wherein the first fastener component is removable from the mounting component.

Aspect 30. The method according to any of Aspects 21 to 29, wherein the second fastener component is removable from the headgear component.

Aspect 31. The method according to any of Aspects 21 to 30, wherein one or both of the mounting component and the headgear component are machine washable.

Aspect 32. The method according to any of Aspects 21 to 31, wherein the first fastener component and the second fastener component comprise a plurality of magnets, a hook and loop fastener, a buckle, a snap, or a combination thereof.

Aspect 33. The method according to any of Aspects 21 to 32, wherein the headgear component comprises a hat, a cap, a visor, a headband, a strap, a drawstring, or a combination thereof.

Aspect 34. The method according to any of Aspects 21 to 33, wherein one or both of the mounting component and the headgear component comprise a logo.

Aspect 35. The method according to any of Aspects 21 to 34, wherein one or both of the first fastener component and the second fastening component are removably contained within a pocket in the mounting component or the headgear component.

Aspect 36. The method according to Aspects 35, wherein the pocket is scalable.

Aspect 37. The method according to Aspect 36, wherein the pocket comprises a zipper or a hook and loop fastener.

Aspect 38. The method according to Aspect 21, wherein the mounting component comprising the first fastener component is directly attached to a seat of a vehicle or is incorporated within the seat of the vehicle.

Aspect 39. The method according to any of Aspects 21 to 38, wherein the mounting component prevents the head of the user from direct contact with a seat of a vehicle.

Aspect 40. The method according to any of Aspects 21 to 39, wherein the headgear component may be detached from the mounting component without removing the headgear component from the user's forehead.

The above description is intended to be illustrative, and not restrictive. For example, the above-described examples (or one or more aspects thereof) may be used in combination with each other. Other aspects can be used, such as by one of ordinary skill in the art upon reviewing the above description. The Abstract is provided to comply with 37 C.F.R. § 1.72 (b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects can be combined with each other in various combinations or permutations. The scope of the disclosure should be determined with reference to the appended claims, along with the full scope of equivalents to which such claims are entitled.

What is claimed is:

1. A head restraint system comprising:
a mounting component, wherein the mounting component comprises a first fastener component; and
a headgear component adapted to secure a user's forehead, wherein the headgear component comprises a second fastener component,
wherein the first fastener component removably attaches to the second fastener component to secure the mounting component to the headgear component.

2. The head restraint system according to claim 1, wherein the mounting component is adapted to attach to a seat or be incorporated within the seat, or be incorporated within a vertical surface.

3. The head restraint system according to claim 2, wherein the seat is a component of a transportation vehicle, a chair, a couch, or a portable infant seat.

4. The head restraint system according to claim 2, wherein the mounting component comprises a sleeve or a strap adapted to attach to the seat or a portion of the seat, and the first fastener component is retained within or on a surface of the sleeve or strap.

5. The head restraint system according to claim 4, wherein the sleeve comprises a fabric.

6. The head restraint system according to claim 5, wherein the fabric is inelastic.

7. The head restraint system according to claim 5, wherein the fabric comprises a third fastener component to secure the first fastener component to the seat.

8. The head restraint system according claim 4, wherein the sleeve or strap comprise an antimicrobial material or antimicrobial surface treatment.

9. The head restraint system according to claim 1, wherein the first fastener component is removable from the mounting component.

10. The head restraint system according to claim 1, wherein the second fastener component is removable from the headgear component.

11. The head restraint system according to claim 1, wherein one or both of the mounting component and the headgear component are machine washable.

12. The head restraint system according to claim 1, wherein the first fastener component and the second fastener component comprise a plurality of magnets, a hook and loop fastener, a buckle, a snap, or a combination thereof.

13. The head restraint system according to claim 1, wherein the headgear component comprises a hat, a cap, a visor, a headband, a strap, a drawstring, or a combination thereof.

14. The head restraint system according to claim 1, wherein one or both of the mounting component and the headgear component comprise a logo.

15. The head restraint system according to claim 1, wherein one or both of the first fastener component and the second fastening component are removably contained within a pocket in the mounting component or the headgear component.

16. The head restraint system according to claim 15, wherein the pocket is sealable.

17. The head restraint system according to claim 16, wherein the pocket comprises a zipper or a hook and loop fastener.

18. The head restraint system according to claim 1, wherein the mounting component comprising the first fastener component is directly attached to a seat of a vehicle or is incorporated within the seat of the vehicle.

19. The head restraint system according to claim 1, wherein the mounting component prevents the head of the user from direct contact with a seat of a vehicle.

20. The head restraint system according to claim 1. wherein the headgear component may be detached from the mounting component without removing the headgear component from the user's forehead.
